(19) United States
(12) Patent Application Publication
(10) Pub. No.: US 2019/0316619 A1
(43) Pub. Date: Oct. 17, 2019

(54) Method for Bonding Housing and Screen, Housing Assembly, and Mobile Terminal

(71) Applicant: Huawei Technologies Co., Ltd., Shenzhen (CN)

(72) Inventor: Renwei Guo, Shenzhen (CN)

(21) Appl. No.: 16/095,860

(22) PCT Filed: Jul. 27, 2016
(86) PCT No.: PCT/CN2016/091930

§ 371 Date: Oct. 23, 2018

(51) Int. Cl. F16B 11/00; H04M 1/02

(52) U.S. Cl. CPC F16B 11/006; H04M 1/0249

(57) ABSTRACT

A method for bonding a housing and a screen, a housing assembly, and a mobile terminal, where the bonding method includes bonding, to an inner surface of the housing, a polymer layer including a plurality of vias, dispensing glue on the polymer layer bonded on the inner surface of the housing, and bonding the glued polymer layer with the screen. Therefore, the method for bonding the housing and the screen, the housing assembly, and the mobile terminal can expand a specific surface area of glue and enhance bonding strength between the housing and the screen.

### TECHNICAL FIELD

The present invention relates to the field of mobile terminal assembly process technologies, and in particular, to a method for bonding a housing and a screen, a housing assembly, and a mobile terminal in the field of assembly process technologies.

### BACKGROUND

When a mobile terminal with a screen is in use, the screen usually falls off. Bonding strength between a shell and the screen of the mobile terminal is one of important factors that determine quality of the mobile terminal.

In a conventional mobile terminal assembly process, glue is usually dispensed on an inner surface of a housing of a mobile terminal to bond a shell and a screen of the mobile terminal. However, bonding strength is not ideal.

### SUMMARY

The present invention provides a method for bonding a housing and a screen, a housing assembly, and a mobile terminal, so as to enhance bonding strength between the housing and the screen.

According to a first aspect, the present invention provides a method for bonding a housing and a screen, where the method includes:

bonding, to an inner surface of the housing, a polymer layer that includes a plurality of vias;

dispensing glue on the polymer layer bonded on the inner surface of the housing; and

bonding the glued polymer layer with the screen.

According to the method for bonding a housing and a screen provided in the present invention, a polymer layer that includes a plurality of vias is bonded on an inner surface of the housing and glue is dispensed on the polymer layer on the inner surface of the housing, so as to bond the housing with the screen. In this way, a specific surface area of glue can be expanded, so that bonding strength between the housing and the screen can be enhanced.

With reference to the first aspect, in a first possible implementation of the first aspect, the bonding, to an inner surface of the housing, a polymer layer that includes a plurality of vias includes: curing the polymer layer onto the inner surface of the housing by means of ultraviolet curing.

With reference to the first aspect or the first possible implementation of the first aspect, in a second possible implementation of the first aspect, the bonding, to an inner surface of the housing, a polymer layer that includes a plurality of vias includes: coating the inner surface of the housing with curing glue; covering the curing glue with the polymer layer; placing a transparent press-fitting mold on the polymer layer and pressing the transparent press-fitting mold to tightly fit the polymer layer and the housing together; and exposing, to ultraviolet, the transparent press-fitting mold placed on the polymer layer, so as to cure the polymer layer onto the housing.

With reference to the first aspect, or the first or the second possible implementation of the first aspect, in a third possible implementation of the first aspect, the inner surface of the housing includes a first inner surface and a second inner surface, an included angle exists between the first inner surface and the second inner surface, and the bonding, to an inner surface of the housing, a polymer layer that includes a plurality of vias includes: bending the polymer layer; and bonding the bent polymer layer onto the first inner surface and the second inner surface.

According to the method for bonding a housing and a screen provided in the present invention, the first inner surface and the second inner surface that are coated with curing glue are tightly fit with the bent polymer layer by using a transparent press-fitting mold, and the press-fitting mold is exposed to ultraviolet to cure the polymer layer onto the housing. In this way, bonding strength between the housing and the polymer can be enhanced.

With reference to any one of the first aspect, or the first to the third possible implementations of the first aspect, in a fourth possible implementation of the first aspect, the polymer layer is a meshed polymer layer, and before the bonding, to an inner surface of the housing, a polymer layer that includes a plurality of vias, the method further includes preparing the meshed polymer layer in the following manner: coating a substrate with curing glue and performing ultraviolet curing processing on the curing glue to form a flat polymer layer; coating the flat polymer layer with protective glue to form a protective glue layer; performing exposure processing on the protective glue layer through a plurality of light holes of a photomask, so as to form a plurality of exposure areas on the protective glue layer; removing, by using solvent, protective glue from an area on the protective glue layer except the plurality of exposure areas; and performing etching processing on an area that is on the flat polymer layer and not covered by the protective glue layer, so as to form the meshed polymer layer.

According to the method for bonding a housing and a screen provided in the present invention, a component of raw material for preparing a polymer is controlled, so as to prepare polymer with higher bonding strength, and the housing and the screen are bonded by using the polymer with higher bonding strength, so that bonding strength between the housing and the screen is enhanced.

With reference to any one of the first aspect, or the first to the fourth possible implementations of the first aspect, in a fifth possible implementation of the first aspect, the polymer layer includes a plurality of evenly arranged vias.

With reference to any one of the first aspect, or the first to the fifth possible implementations of the first aspect, in a sixth possible implementation of the first aspect, the polymer layer includes a plurality of vias with 0.01 mm to 0.3 mm apertures.

According to the method for bonding a housing and a screen provided in the present invention, a polymer layer with vias that have apertures of different sizes is prepared, so as to meet a design requirement that an adhesive area is smaller in requirements such as a future mobile terminal has a narrower screen bezel and a thinner body.

With reference to any one of the first aspect, or the first to the sixth possible implementations of the first aspect, in a seventh possible implementation of the first aspect, the polymer layer includes a plurality of vias that have a surface in the shape of a square, a circle, a triangle, or a parallelogram.

According to the method for bonding a housing and a screen provided in the present invention, a polymer layer with vias that have different surface shapes is prepared, so as to meet design requirements in various glue dispensing scenarios with different glue dispensing station shapes.

According to a second aspect, the present invention provides a housing assembly, where the housing assembly includes a housing and a polymer layer, the polymer layer includes a plurality of vias, and the polymer layer is cured on an inner surface of the housing.

With reference to the second aspect, in a first possible implementation of the second aspect, the inner surface of the housing includes a first inner surface and a second inner surface, an included angle exists between the first inner surface and the second inner surface, and the polymer layer is bonded with both the first inner surface and the second inner surface after being bent.

According to a third aspect, the present invention provides a mobile terminal, where the mobile terminal includes a screen and a housing, and the screen and the housing are bonded by using the method according to any one of the first aspect or the possible implementations of the first aspect.

### BRIEF DESCRIPTION OF DRAWINGS

To describe the technical solutions in the embodiments of the present invention more clearly, the following briefly describes the accompanying drawings required for describing the embodiments.

FIG. 1 is a schematic structural diagram of a screen and a housing of a mobile terminal;

FIG. 2 is a schematic flowchart of a method for bonding a housing and a screen according to an embodiment of the present invention;

FIG. 3 is a schematic structural diagram of a polymer layer according to an embodiment of the present invention;

FIG. 4 is a schematic diagram of a surface shape of a via on a polymer layer according to an embodiment of the present invention;

FIG. 5 is a schematic diagram of a polymer layer and housing bonding method according to an embodiment of the present invention;

FIG. 6 is a schematic diagram of a glue dispensing method according to an embodiment of the present invention;

FIG. 7 is a schematic diagram of a method for bonding a housing and a screen according to an embodiment of the present invention;

FIG. 8 is a schematic diagram of a method for preparing a meshed polymer layer according to an embodiment of the present invention;

FIG. 9 is a schematic diagram of another method for preparing a meshed polymer layer according to an embodiment of the present invention;

FIG. 10 is a schematic diagram of a meshed protective glue layer according to an embodiment of the present invention;

FIG. 11 is a schematic diagram of a photomask according to an embodiment of the present invention;

FIG. 12 is a schematic diagram of still another method for preparing a polymer layer according to an embodiment of the present invention;

FIG. 13 is a schematic structural diagram of a housing assembly according to an embodiment of the present invention; and

FIG. 14 is a schematic structural diagram of a mobile terminal according to an embodiment of the present invention.

### DESCRIPTION OF EMBODIMENTS

The following describes the technical solutions in the embodiments of the present invention with reference to the accompanying drawings in the embodiments of the present invention.

The technical solutions in the embodiments of the present invention may be applied to all mobile terminals with a screen. For example, a mobile terminal may be a mobile telephone, a tablet personal computer (Tablet Personal Computer), a media player, a smart television, a laptop computer (Laptop Computer), a personal digital assistant (personal digital assistant, PDA), a personal computer (Personal Computer), a mobile Internet device (Mobile Internet Device), or a wearable device (Wearable Device) such as a smartwatch, or the like that has a screen. The embodiments of the present invention do not impose a limitation thereto.

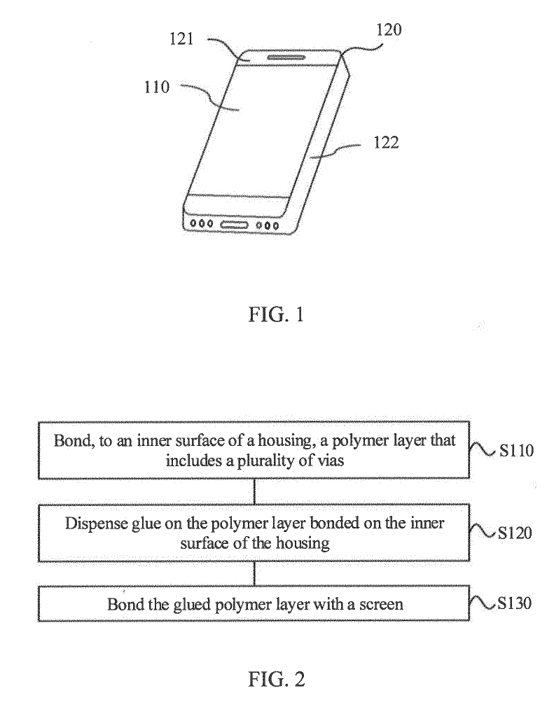

FIG. 1 shows a schematic structural diagram of a screen and a housing of a mobile terminal. As shown in FIG. 1, the mobile terminal with a screen includes a screen 110 and a housing 120. An inner surface of the housing 120 may include a bottom face 121 and four side faces (a side face 122 is shown in FIG. 1). A same included angle exists between the bottom face and each side face. In an existing mobile terminal assembly method, after the inner surface of the housing 120 is dispensed with glue, the screen 110 is bonded into the housing 120.

Because the inner surface of the housing is relatively smooth, when the screen is directly bonded with the housing by means of glue dispensing, bonding strength is not ideal, and the screen easily falls off.

FIG. 2 shows a schematic flowchart of a method for bonding a housing and a screen 100 according to an embodiment of the present invention.

S110. Bond, to an inner surface of the housing, a polymer layer that includes a plurality of vias.

S120. Dispense glue on the polymer layer bonded on the inner surface of the housing.

S130. Bond the glued polymer layer with the screen.

It should be understood that the vias may be holes that pass through top and bottom surfaces of the polymer layer.

According to the method for bonding a housing and a screen in this embodiment of the present invention, because a polymer layer bonded on an inner surface of a housing includes a plurality of vias, during glue dispensing on the polymer layer, glue may be poured into a groove that is formed after the vias on the polymer layer are bonded with the housing. In this way, the groove can accommodate more glue, and the glue can fit with a groove wall of the groove, thereby expanding a specific surface area of the glue, so that bonding strength between the polymer layer and the screen can be enhanced.

It should be understood that the polymer layer in this embodiment of the present invention may be high polymer and can be reliably cured on the inner surface of the housing. In addition, surface morphology of the polymer layer is relatively complex and can improve surface roughness of the polymer layer, thereby enhancing bonding strength between the polymer layer and the screen.

In addition, material of the polymer layer in this embodiment of the present invention is also elastic and rigid, and therefore can play a buffering role. When the terminal device falls from a high place, the polymer layer can protect the screen.

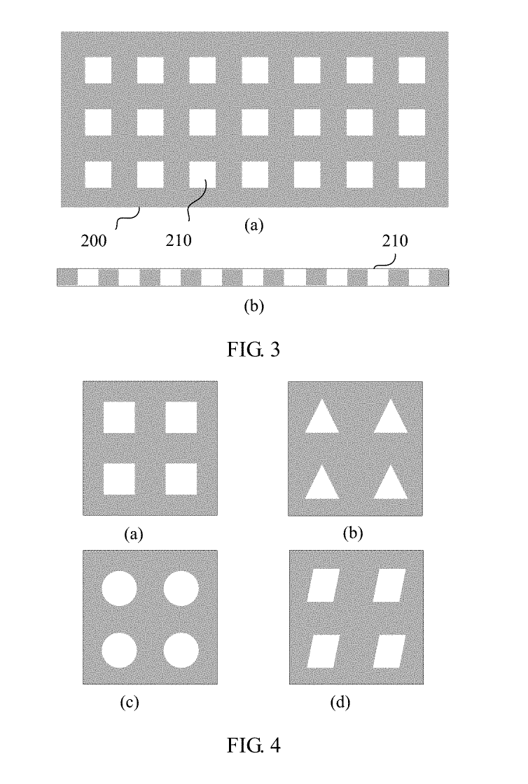

The following describes the method for bonding a housing and a screen 100 according to this embodiment of the present invention with reference to FIG. 3 to FIG. 12, but this embodiment of the present invention is not limited thereto.

FIG. 3 shows a schematic structural diagram of a polymer layer 200 according to an embodiment of the present invention. In FIG. 3, (a) shows a planar diagram of the polymer layer 200 according to this embodiment of the present invention, and (b) in FIG. 3 shows a side view of the polymer layer 200 according to this embodiment of the present invention.

As shown in (a) in FIG. 3, the polymer layer 200 may include a plurality of vias (a via 210 is shown in the figure). The plurality of vias may be irregularly arranged or evenly arranged. The polymer layer, for example, may be a meshed polymer layer, and this embodiment of the present invention does not impose a limitation thereto.

Optionally, the polymer layer may be highly elastic and rigid material, for example, may be material such as nylon. In addition, because the polymer layer may be meshed, for example, may be a fishing-net polymer layer, surface morphology of a contact surface is complex and roughness of a bonding surface can be improved.

Optionally, apertures of the vias on the polymer layer may be 0.01 mm to 0.3 mm.

According to the method for bonding a housing and a screen in this embodiment of the present invention, a design requirement that an adhesive area is smaller in requirements such as a future mobile terminal has a narrower screen bezel and a thinner body can be met. In addition, this avoids an aperture from being extremely small, avoids surface morphology features of the housing from being overly similar, and avoids failing to improve surface roughness of the housing.

FIG. 4 shows a schematic diagram of a surface shape of a via according to an embodiment of the present invention. As shown in FIG. 4, the surface shape of the via on the meshed polymer layer may be a square shown in (a) in FIG. 4, a triangle shown in (b) in FIG. 4, a circle shown in (c) in FIG. 4, or a parallelogram shown in (d) in FIG. 4, or a via surface shape determined according to a shape of glue dispensing stations in different shapes, but this embodiment of the present invention is not limited thereto.

According to the method for bonding a housing and a screen provided in this embodiment of the present invention, the surface shape of the via on the polymer layer is controlled, so that design requirements for different glue dispensing station shapes in various glue dispensing scenarios can be met.

Optionally, according to the method for bonding a housing and a screen provided in this embodiment of the present invention, the polymer layer may be bonded on the inner surface of the housing by means of ultraviolet curing or glue bonding. This embodiment of the present invention does not impose a limitation thereto.

Optionally, the inner surface of the housing may include a first inner surface and a second inner surface, and an included angle exists between the first inner surface and the second inner surface. The first inner surface may be a bottom face of the inner surface of the housing, and the second inner surface may be a side face of the inner surface of the housing.

Optionally, the housing may include a plurality of side faces and an included angle exists between the bottom face and each of the plurality of side faces. This embodiment of the present invention does not impose a limitation thereto.

Specifically, in S110, the polymer layer may be bent and the bent polymer layer may be bonded onto the first inner surface and the second inner surface.

According to the method for bonding a housing and a screen provided in the present invention, the first inner surface and the second inner surface that are coated with curing glue are tightly fit with the bent polymer layer by using a transparent press-fitting mold, and the press-fitting mold is exposed to ultraviolet to cure the polymer layer onto the housing. In this way, bonding strength between the housing and the polymer can be enhanced.

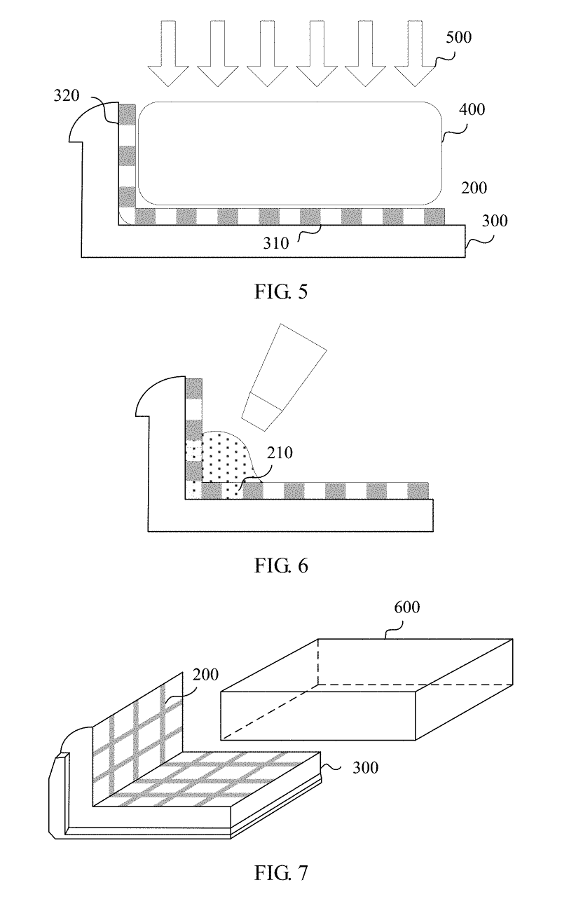

In an optional embodiment, FIG. 5 shows a schematic diagram of a polymer layer and housing bonding method according to an embodiment of the present invention. As shown in FIG. 5, an inner surface of the housing 300 may be coated with curing glue, the curing glue may be covered with the polymer layer 200 shown in FIG. 3, a transparent press-fitting mold 400 may be placed on the polymer layer, press-fitting processing may be performed on the curing glue and the polymer layer, and ultraviolet curing processing may be performed on the polymer layer by exposing the polymer layer on the housing to ultraviolet 500 by using the transparent press-fitting mold placed on the polymer layer, so that the polymer layer with vias is cured on the inner surface of the housing.

It should be understood that the transparent press-fitting mold 400 is relatively heavy, and therefore, placing the transparent press-fitting mold on the polymer layer that covers the curing glue enables the polymer layer to fully touch and tightly fit with the curing glue. In addition, because the transparent press-fitting mold 400 is transparent, when the transparent press-fitting mold is performing press-fitting on the polymer layer, the transparent press-fitting mold may be exposed to ultraviolet, so that bonding strength between the polymer layer and the inner surface of the housing can be further enhanced.

It should be further understood that because the polymer layer can be bent, when the polymer layer is covering the inner surface that is of the housing and coated with the curing glue, the polymer layer can be fully fit with the bottom face and the side face included in the inner surface of the housing.

Optionally, the polymer layer may cover only the bottom face 310 or the side face 320 of the inner surface of the housing 300, or may cover both the bottom face and the side face of the inner surface of the housing. This embodiment of the present invention does not impose a limitation thereto.

FIG. 6 shows a schematic diagram of a glue dispensing method according to an embodiment of the present invention. As shown in FIG. 6, during glue dispensing, glue may be dispensed on a polymer layer that is cured on an inner surface of a housing. Because the polymer layer bonded on the inner surface of the housing includes a plurality of vias, during glue dispensing on the polymer layer, glue may be poured into a groove (for example, a groove formed between the via 210 and the housing in FIG. 6) that is formed after the vias on the polymer layer are bonded with the housing. In this way, the groove can accommodate more glue, and the glue can fit with a groove wall of the groove, thereby expanding a specific surface area of the glue, so that bonding strength between the polymer layer and the screen can be enhanced.

Optionally, glue may be dispensed on the polymer layer on the included angle between the bottom face and the side face of the inner surface of the housing, and after a screen covers the glued polymer layer and press-fitting is performed, the glue can cover the entire polymer layer and overflow of excessive glue is prevented.

FIG. 7 shows a schematic diagram of a method for bonding a housing and a screen according to an embodiment of the present invention. As shown in FIG. 7, glue is dispensed on a polymer layer 200 that is cured on an inner surface of a housing 300, and a screen 600 is placed inside the housing 300, so that the screen 600 is bonded with the housing 300.

It should be understood that FIG. 7 merely illustrates the method for bonding a housing and a screen by using a schematic diagram of a part (one side face and a bottom face) of a housing as an example, but this embodiment of the present invention is not limited thereto.

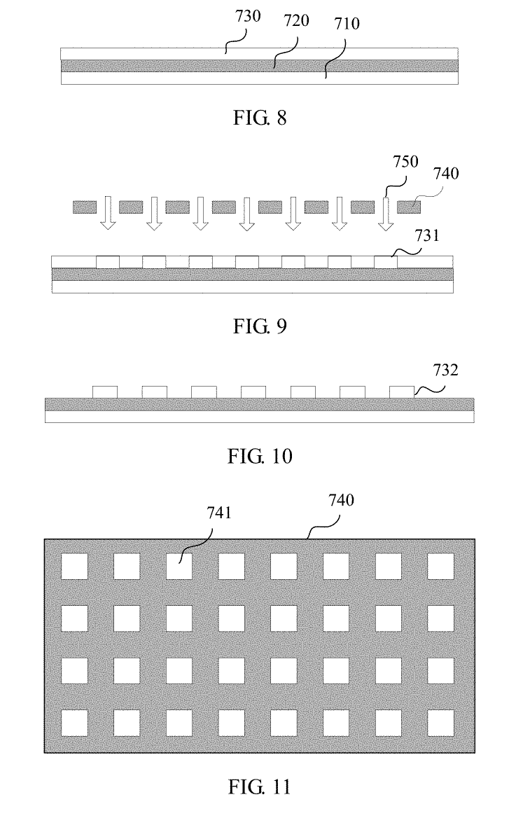

The foregoing has described the method for bonding a housing and a screen according to the embodiments of the present invention with reference to FIG. 1 to FIG. 7. The following describes in detail methods for preparing a meshed polymer layer according to embodiments of the present invention with reference to FIG. 8 to FIG. 12.

In an optional embodiment, FIG. 8 shows a schematic diagram of a method for preparing a meshed polymer layer according to an embodiment of the present invention. As shown in FIG. 8, the polymer layer may be prepared in the following manner, including: coating a substrate 710 with curing glue and performing ultraviolet curing processing to form a flat polymer layer 720; and coating the flat polymer layer 720 with protective glue and performing ultraviolet curing processing to form a protective glue layer 730. The flat polymer layer 720 is used to obtain a to-be-prepared meshed polymer layer after the following processing is performed, and the protective glue layer 730 is used to form a graphical layer for preparing a meshed polymer layer.

FIG. 9 shows a schematic diagram of another method for preparing a polymer layer according to an embodiment of the present invention. As shown in FIG. 9, a laser beam 750 passes through a photomask 740 to perform exposure on the protective glue layer 730 in FIG. 8, so as to form a plurality of exposure areas (an exposure area 731 is shown in FIG. 9). Solvent is used to remove protective glue from an area on the protective glue layer 730 except the plurality of exposure areas, so as to obtain a meshed protective glue layer 732 shown in FIG. 10.

FIG. 11 shows a schematic diagram of a photomask according to an embodiment of the present invention. As shown in FIG. 11, exposure may be performed on the protective glue layer according to the photomask 740. The photomask includes a plurality of light holes (a light hole 741 is shown in FIG. 11). A light beam passes through the plurality of light holes and forms, on the protective glue layer, a plurality of exposure areas corresponding to the plurality of light holes. Solvent is used to remove protective glue from an area on the protective glue layer except the plurality of exposure areas, so as to form the meshed protective glue layer 732 shown in FIG. 10.

Optionally, in this embodiment of the present invention, laser may also be used to draw a pattern directly on the protective glue layer, and protective glue out of a graphical area is removed by using solvent, so as to obtain a meshed protective glue layer. However, this embodiment of the present invention is not limited thereto.

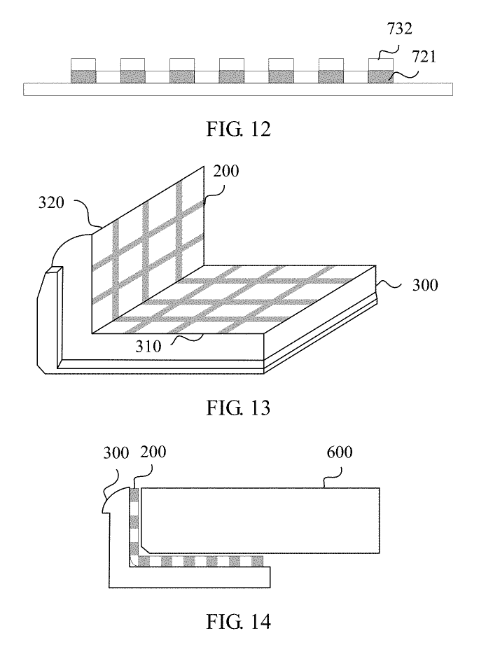

FIG. 12 shows a schematic diagram of still another method for preparing a polymer layer according to an embodiment of the present invention. As shown in FIG. 12, etching is performed on the flat polymer layer according to a meshed pattern on the meshed protective glue layer 732; polymer on an area not covered by the protective glue layer is removed from the flat polymer layer, and only polymer in an area (an area 721 shown in FIG. 12) covered by the protective glue is left; and finally, the protective glue on the protective glue layer is removed by using solvent, and a meshed polymer layer of a structure similar to that of the meshed protective glue layer is obtained.

Optionally, a rigid and elastic polymer layer may be prepared by adjusting material and a raw material component that are used for preparing the polymer layer in the embodiment of the present invention. For example, the polymer layer may be high polymer such as nylon. The polymer layer can enhance bonding strength between the polymer layer and another surface, but this embodiment of the present invention does not impose a limitation thereto.

The foregoing has described the method for bonding a housing and a screen according to the embodiments of the present invention with reference to FIG. 1 to FIG. 12. The following describes a housing assembly and a mobile terminal according to embodiments of the present invention with reference to FIG. 13 and FIG. 14.

FIG. 13 shows a housing assembly according to an embodiment of the present invention. The housing assembly includes a housing 300 and a polymer layer 200. The polymer layer 200 includes a plurality of vias, and the polymer layer may be cured on an inner surface of the housing by means of ultraviolet curing.

Optionally, the inner surface of the housing may include a first inner surface (for example, a bottom face 310 in FIG. 13) and a second inner surface (for example, a side face 320 in FIG. 13), an included angle exists between the first inner surface and the second inner surface, and the polymer layer is bonded with both the first inner surface and the second inner surface after being bent.

Because a polymer layer of a housing assembly in this embodiment of the present invention includes a plurality of vias, during glue dispensing on the polymer layer, glue may be poured into a groove that is formed after the vias on the polymer layer are bonded with a housing. In this way, the groove can accommodate more glue, and the glue can fit with a groove wall of the groove, thereby expanding a specific surface area of the glue, so that bonding strength between the polymer layer and the screen can be enhanced.

Optionally, the polymer layer of the housing assembly in this embodiment of the present invention may be a meshed polymer layer, and the meshed polymer layer is cured on a surface of the housing. In this way, surface roughness of the housing can be improved, so that bonding strength between the housing and the screen is enhanced.

In addition, material of the polymer layer of the housing assembly in this embodiment of the present invention is also elastic and rigid, and therefore can play a buffering role. When the terminal device falls from a high place, the polymer layer can protect the screen.

FIG. 14 shows a partial side view of a mobile terminal according to an embodiment of the present invention. The mobile terminal includes a screen 600 and a housing 300. The screen 600 and the housing 300 are bonded according to the bonding methods described in FIG. 1 to FIG. 12 by using a polymer layer 200 that includes a plurality of vias. To avoid repetition, details are not described herein.

In an implementation process, steps in the foregoing methods can be implemented by using a hardware integrated logical circuit in the processor, or by using instructions in a form of software. The steps of the method disclosed with reference to the embodiments of the present invention may be directly performed by a hardware processor, or may be performed by using a combination of hardware in the processor and a software module. A software module may be located in a mature storage medium in the art, such as a random access memory, a flash memory, a read-only memory, a programmable read-only memory, an electrically erasable programmable memory, a register, or the like. The storage medium is located in the memory, and a processor reads instructions in the memory and completes the steps in the foregoing methods in combination with hardware of the processor. To avoid repetition, details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present invention.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (read-only memory, ROM for short), a random access memory (random access memory, RAM for short), a magnetic disk, or an optical disc.

The foregoing descriptions are merely specific embodiments of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

1. A method for bonding a housing and a screen, comprising:
bonding a polymer layer comprising a plurality of vias to an inner surface of the housing;
dispensing glue on the polymer layer bonded on the inner surface of the housing; and
bonding the glued polymer layer with the screen.

2. The bonding method of claim 1, wherein bonding the polymer layer to the inner surface of the housing comprises curing the polymer layer onto the inner surface of the housing by ultraviolet curing.

3. The bonding method of claim 1, wherein bonding the polymer layer to the inner surface of the housing comprises:
coating the inner surface of the housing with curing glue;
covering the curing glue with the polymer layer;
placing a transparent press-fitting mold on the polymer layer;
pressing the transparent press-fitting mold to tightly fit the polymer layer and the housing together; and
exposing the transparent press-fitting mold placed on the polymer layer to ultraviolet to cure the polymer layer onto the housing.

4. The bonding method of claim 1, wherein the inner surface of the housing comprises a first inner surface and a second inner surface, an included angle existing between the first inner surface and the second inner surface, and bonding the polymer layer to the inner surface of the housing comprising:
bending the polymer layer; and
bonding the bent polymer layer onto the first inner surface and the second inner surface.

5. The bonding method of claim 1, wherein the polymer layer comprises a meshed polymer layer, and before bonding the polymer layer to the inner surface of the housing, the method further comprising preparing the meshed polymer layer in a manner of:
coating a substrate with curing glue;
performing ultraviolet curing processing on the curing glue to form a flat polymer layer;
coating the flat polymer layer with protective glue to form a protective glue layer;
performing exposure processing on the protective glue layer through a plurality of light holes of a photomask to form a plurality of exposure areas on the protective glue layer;
removing, using a solvent, the protective glue from an area on the protective glue layer except the exposure areas; and
performing etching processing on an area on the flat polymer layer exposed from the protective glue layer to form the meshed polymer layer.

6. The bonding method of claim 1, wherein the vias are evenly arranged.

7. The bonding method of claim 1, wherein the vias comprises 0.01 millimeters (mm) to 0.3 mm apertures.

8. The bonding method of claim 1, wherein the vias having a surface in a shape of a square.

9. A housing assembly, comprising:
a housing; and
a polymer layer comprising a plurality of vias, the polymer layer being cured on an inner surface of the housing.

10. The housing assembly of claim 9, wherein the inner surface of the housing comprises a first inner surface and a second inner surface, an included angle existing between the first inner surface and the second inner surface, and the polymer layer being bonded with both the first inner surface and the second inner surface after being bent.

11. A mobile terminal, comprising:
a housing, an inner surface of the housing being bonded to a glue dispensed polymer layer, and the polymer layer comprising a plurality of vias; and
a screen bonded with the glue dispensed polymer layer.

12. The bonding method of claim 1, wherein the vias having a surface in a shape of a circle.

13. The bonding method of claim 1, wherein the vias having a surface in a shape of a triangle.

14. The bonding method of claim 1, wherein the vias having a surface in a shape of a parallelogram.
